(19) United States
(12) Patent Application Publication
(10) Pub. No.: US 2026/0062346 A1
(43) Pub. Date: Mar. 5, 2026

(54) LOOSEFILL INSULATION MATERIALS AND METHODS FOR MAKING THEM

(71) Applicant: CERTAINTEED LLC, Malvern, PA (US)

(72) Inventors: Atchyutha Sreya Manju BHAMIDIPATI, King of Prussia, PA (US); Thomas Barres, Rantigny (FR); Pierre Lombard, Malvern, PA (US)

(21) Appl. No.: 19/318,467

(22) Filed: Sep. 4, 2025

Related U.S. Application Data
(60) Provisional application No. 63/690,580, filed on Sep. 4, 2024.

(51) Int. Cl. C03C 25/255; C03C 13/00; C03C 25/40; C09D 7/20; C09D 183/04

(52) U.S. Cl. CPC C03C 25/255; C03C 13/00; C03C 25/40; C09D 7/20; C09D 183/04

(57) ABSTRACT

A loosefill insulation product is disclosed. The loosefill insulation product can include a plurality of insulation fibers and a coating on the plurality of insulation fibers. The coating can include a silicone, and an oil. The loosefill insulation product leaches less than detectable amounts of alkali or alkaline-earth metals based on the total weight of the loosefill insulation product when analyzed with SEM/EDS analysis. The loosefill insulation product has an improved corrosion inhibition effect on aging, and passes the corrosion test as per ASTM C764.

### CROSS-REFERENCE TO RELATED APPLICATION(S)

This application claims priority under 35 U.S.C. § 119 (c) to U.S. Provisional Patent Application No. 63/690,580, entitled “LOOSEFILL INSULATION MATERIALS AND METHODS FOR MAKING THEM,” filed Sep. 4, 2024, by Atchyutha Sreya Manju BHAMIDIPATI et al., which is assigned to the current assignee hereof and is incorporated herein by reference in its entirety.

### FIELD OF THE DISCLOSURE

The present disclosure generally relates to loosefill insulation and more particularly to additives used with glass fibers.

### BACKGROUND

Loosefill insulation is traditionally non-bonded loosefill material in the form of discrete flakes or nodules. Loosefill insulation is typically compressed and packaged into bags. The loosefill installation is performed by blowing the material through a hose connected to a pneumatic device and applied into insulation cavities of sidewalls or into attics. The blowing process desirably uncompresses the loosefill insulation to provide it with a desired low density. Typically, loosefill insulation is made of glass fibers, although other mineral fibers and organic fibers can be used.

Silicones are often applied to the fibers of insulation materials to improve fiber-to-fiber lubricity. In loosefill insulation, the silicones help the material to decompress during blowing. However, as the fibers are exposed to the environment and particularly moisture or hydrolytic attacks, the fibers will begin to age and deteriorate. Hydrolytic attacks can include metal leaching of alkali metals from the mineral material leading to decreased performance of the insulation.

There exists a need in the art for improved loosefill insulation, particularly understanding problems that arise.

### SUMMARY

According to one embodiment, a loosefill product is disclosed. The product can include a fiber insulation wool with a plurality of fibers and coating on the fiber insulation wool. The coating can include a silicone and oil. The loosefill insulation product can leach less than detectable amounts of alkali or alkaline-earth metals based on the total weight of the loosefill insulation product when tested by SEM/EDS analysis.

According to a further embodiment, a method of making a loosefill insulation product is disclosed. Such a method can include: applying a coating on a plurality of fibers of a fiber insulation wool, where the coating can include a silicone and an oil. The loosefill insulation product can leach less than detectable amounts of alkali or alkaline-earth metals based on the total weight of the loosefill insulation product when tested by SEM/EDS analysis.

According to one embodiment, a loosefill product is disclosed. The product can include a fiber insulation wool with a plurality of fibers and coating on the fiber insulation wool. The coating can include a silicone and oil. The loosefill insulation product passing a corrosion test in accordance to ASTM C764.

### BRIEF DESCRIPTION OF THE DRAWINGS

The present disclosure may be better understood, and its numerous features and advantages made apparent to those skilled in the art by referencing the accompanying drawings.

FIG. 1 includes a method of manufacturing a loosefill insulation material, according to one embodiment of the disclosure.

FIG. 2 includes a schematic view of an insulated structure, according to one embodiment of the disclosure.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. The drawings are not necessarily to scale, and sizes of various elements may be distorted for clarity. The drawings illustrate one or more embodiment(s) of the disclosure and together with the description serve to explain the principles and operation of the disclosure.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The use of the word “about,” “approximately,” or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the construction products arts.

Various embodiments of the present disclosure will now be described, by way of example only, with reference to the accompanying drawings.

The present disclosure relates to a loosefill insulation products able to withstand aging and reduce alkali metal leakage. The loosefill products include a coating on a plurality of fibers of a fiber insulation wool, where the coating can include a silicone and an oil.

As one of skill in the art will appreciate, there can be varying materials that may be included as part of the loosefill insulation. These materials can include, but are not limited to, fiberglass, stone wool, cellulose, natural fibers, cotton, polymer fibers, plastic fibers, mineral (rock or slag) wool, fireproofing materials, and other granular or fibrous materials.

Loosefill insulation materials, and especially fibers, are prone to degradation upon exposure to hydrolytic environments. Over time, fibers can begin to corrode and breakdown leading to a leaching of alkali or alkaline-earth metals. While certain materials, such as conventional silicone coatings, can improve inter-fiber lubricity and help prevent moisture absorption, corrosion of the fibers still occurs due to silicone breakdown. Without intending to be bound by theory, according to one aspect of the disclosure, unexpectedly when the loosefill insulation fibers are coated with a combination of silicone and oil as described herein, the loosefill insulation product leaches less than detectable of alkali or alkaline-earth metals based on the total weight of the loosefill insulation product when analyzed by SEM/EDS analysis. The loosefill insulation fibers coated with a combination of silicone and oil as described herein pass the corrosion test set out in ASTM C764, thus inhibiting corrosion.

The loosefill insulation can include a plurality of fibers made from a variety of materials. In one embodiment, the fibers can be made from a variety of glasses, silicate glass, borosilicate glass, aluminosilicate glass, and aluminoborosilicate glass. In another embodiment, the fibers can include at least one organic material selected from the group consisting of animal fibers, cellulose-containing vegetable fibers, cotton, rayon granulated cork, redwood wool, recycled, ground, or shredded newspaper fibers, polyester, other thermoplastic fibers, or any combination thereof. In another embodiment, the fibers comprise at least one inorganic material selected from the group consisting of perlite, fibrous potassium titanate, alumina-silica fibers, micro quartz fibers, opacified colloidal alumina, zirconia fibers, carbon fibers, basalt fibers, aramid fibers, granulated charcoal, graphite fibers, cement fibers, rock fibers, slag fibers, glass wool, rock wool, or any combination thereof.

The fibers of the loosefill insulation are desirably relatively fine, so as to provide materials that can be installed by blowing to provide a relatively high degree of insulation. In certain embodiments as otherwise described herein, the median diameter of the fibers of the loosefill insulation (i.e., taken for each fiber as the maximum distance across the fiber in a direction perpendicular to the length of the fiber) is no more than about 100 microns, e.g., no more than about 50 microns or even no more than about 20 microns. In one embodiment, the median length of the collection of fibers is no more than 500 mm, e.g., no more than 250 mm, or no more than 100 mm. In another embodiment, the fibers of the loosefill insulation can have a median diameter of at least 1 nm, such as at least 5 nm, or at least 10 nm.

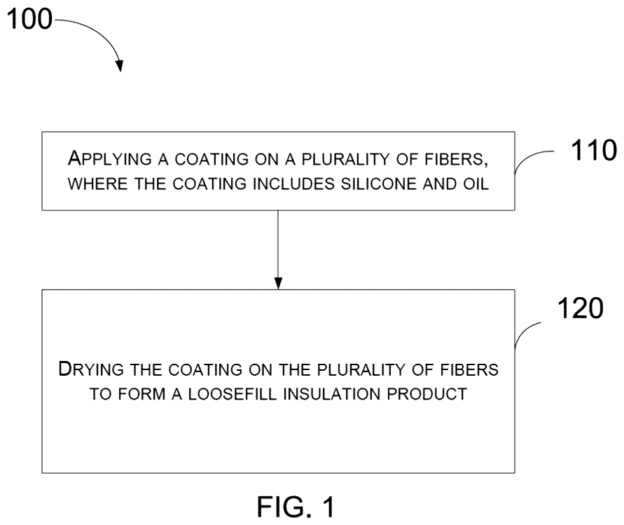

Another aspect of the disclosure is a coated loosefill insulation product made by a process as described herein. FIG. 1 includes a method of manufacturing a loosefill insulation material, according to one embodiment of the disclosure. The loosefill insulation itself can be made using conventional methods, from a number of different materials, e.g., glass, rock or stone (e.g., basalt or diabase, or other volcanic or subvolcanic rock), and at least partially purified mineral, slag, or a mixture thereof. Typically, the mineral source is molten and formed into fibers, using any of a number of spinning, centrifugation, drawing, or other fiberizing processes. The fiberizing process can provide fibers of a desired length, or fibers can be chopped to a desired size.

As seen at operation 110, a coating can be applied on the loosefill insulation fibers. The resulting fibers can then be coated with one or more coatings or other treatments, as described herein. The fibers can be collected, further treated if desired, and then packaged. A person of ordinary skill in the art will appreciate that the layer of coating on the fibers, especially when formed from droplets in a spray, may not be of a single uniform thickness, but rather may have significant variations in thickness and coverage on individual fibers and even on different areas of individual filers. Nonetheless, the amount of coating on a collection of fibers can be characterized by an overall amount of coating as a wt % of overall fiber mass. In one embodiment, the coating can include a silicone and an oil. In another embodiment, the coating can include a silicone in an amount less than 0.1 wt % of silicone based on the weight of the fibers and an oil in an amount less than 0.7 wt % of oil based on the weight of the fibers.

In one embodiment, the amount of silicone in the coating composition can be less than 0.1 wt % of silicone based on the weight of the fibers, such as less than 0.01 wt % or such as less than 0.05 wt %. In one embodiment, the amount of silicone in the coating composition can be at least 0.01 wt % of silicone based on the weight of the fibers. In one embodiment, the amount of oil in the coating composition can be less than 0.7 wt % of oil based on the weight of the fibers, such as less than 0.6 wt % or less than 0.5 wt %, such as less than 0.4 wt %, or such as less than 0.3 wt %. In one embodiment, the amount of oil in the coating composition can be at least 0.01 wt % of oil based on the weight of the fibers.

The coating on the fibers can include a variety of silicones and oils and can be used in the methods and materials described herein. In one embodiment, the silicone can be a polysiloxane, e.g., a polymer or copolymer of one or more of an alkylsiloxane such as dimethylsiloxane and methylsiloxane; and arylsiloxane such as phenylmethylsiloxane, 2-phenylpropylmethylsiloxane, and phenylsiloxane; and a functionalized siloxane such as 3-aminopropylmethylsiloxane, and aminoethylaminopropylmethoxysiloxane, or any combination thereof. In certain embodiments, the silicone is a poly(dimethylsiloxane). The silicone can be terminated in any convenient way, e.g., trimethylsilyl, hydroxy, or hydride. In one embodiment, the silicone can have a number average molecular weight of less than 20 kDa, such as less than 19 kDa, or such as less than 18 kDa, or such as less than 15 kDa. In another embodiment, the silicone can have a number average molecular weight of more than 20 kDa, such as greater than 25 kDa, or greater than 50 kDa, or greater than 60 kDa. The molecular weight of the silicone can be determined through matrix-assisted laser desorption ionization-time of flight secondary ion mass spectrometry (MALDI-TOF SIMS). The coated fiber materials described herein can be provided with a variety of densities in the range of 0.1-20 lb/ft³, such as in a range between 0.25-8 lb/ft³, or such as in a range between 0.25-2 lb/ft³, or such as in a range between 0.25-0.75 lb/ft³, or such as in a range between 0.25-0.510 lb/ft³.

In one embodiment, the oil in the coating can be at least one of vegetable oils, natural oils primarily unsaturated triglycerides such as corn oil, paraffinic oil, soya and coconut, mineral oils, or any combination thereof. In one embodiment, the oil can be undiluted. In another embodiment, a dedusting oil (e.g., a bright stock oil) can be applied silicone and oil mixture in the coating to suppress dust in the final product. The dedusting oil can be included in an amount greater than zero and less than 0.5% by weight of the fibers. Conventional oils can be used, e.g., Telura™ 720E or Prorex 100 from Exxon-Mobil. In another embodiment, a surfactant (e.g., nonionic or cationic, such as a mono-, di- or tri-fatty acid ester) can be included in the oil. The surfactant can be included in an amount greater than zero and less than 0.5 wt % of the fibers.

Conventional coating methods can be used to apply the coating composition to the insulation fibers. In one embodiment, a manufacturing method can include coating the fibers after they are formed as the fibers fall vertically through a cooling zone to be collected; the coating composition can be sprayed on the fibers of the loosefill insulation as they fall. The rate of spraying can be adjusted with respect to the rate of formation of the fibers to provide a desired amount of coating on the fibers. Of course, other application methods can be used.

The fibers can contain additional additives. In one embodiment, an antistatic additive, such as a quaternary ammonium salt, can be applied to the loosefill insulation fibers (e.g., by spray application from aqueous solution), in an amount effective to prevent static buildup in the final product. These and other additional materials can be applied to the insulation fibers in any desirable order. In one embodiment, an antistatic additive can be applied to the fibers after the coating composition is applied. In another embodiment, one or more of these and other additional materials are applied at the same time as coating composition. In one embodiment, the additives can be mixed with the silicone and oil composition coating and then applied to the fibers.

As seen at operation 120, the coating on the fibers can be allowed to dry. Once the coating composition is applied, the solvent can be allowed to evaporate to provide a coated fiber. While no special arrangements need be made to evaporate the solvent, in one embodiment, the coated fibers can be heated or subjected to a flow of air or other process gas in order to evaporate the solvent. In certain embodiments, the coated fibers can be formed as an unbound loosefill material, i.e., substantially no binder is applied to the fibers. Such a material can be provided as relatively short fibers, suitable for installation using conventional loosefill installation methods, e.g., by being blown through a hose for disposition against an interior surface of a building. In another embodiment, the coated fiber material described herein can be packaged, e.g., by being compressed and packaged, e.g., into bags or other sealed containers. In one embodiment, the loosefill insulation product leaches less than detectable amounts of alkali or alkaline-earth metals based on the total weight of the loosefill insulation product when tested by SEM/EDS analysis. In one embodiment, the loosefill insulation product leaches less than trace amounts of alkali or alkaline-earth metals based on the total weight of the loosefill insulation product when tested by SEM/EDS analysis. In one embodiment, the loosefill insulation product leaches less than 0.01 g, such as less than 0.001 g, or less than 0.0001 g of alkali or alkaline-earth metals based on the total weight of the loosefill insulation product when analyzed with SEM/EDS analysis.

In another embodiment, the loosefill insulation product leaches less than detectable amounts of alkali or alkaline-earth metals based on the total weight of the loosefill insulation product when analyzed with SEM/EDS analysis.

TABLE 1
Alkali leaching in various examples.

| SAMPLE | % wt Silicone | % wt Oil | ASTM C764 | Detected leaching |
|---|---|---|---|---|
| 1 | 0.09 | 1.35 | Fail | Detected Group |
| | | | | 1A/2A elements |
| 2 | 0.14 | 1.35 | Fail | Detected Group |
| | | | | 1A/2A elements |
| 3 | 0.07 | 0.67 | Pass | None |

Samples 1-3 of Table 1 were each prepared using a coating as described respective for each sample in Table 1. An unbound white virgin loose fill fiber glass insulation fiber, such as Insulsafe® XC sold by CertainTeed, is coated with an oil that includes glycerol monooleate kosher in the respective amounts given in Table 1. Testing the samples in accordance with ASTM C764-19, creates favorable conditions for a lixiviation process resulting in mobile ions being able to react with water and carbon dioxide. As can be seen, sample 3 that has reduced amounts of silicone and oil combination has an improved corrosion inhibition effect on aging, and passes the corrosion test as per ASTM C764-19. The said sample 3 was then analyzed along with samples 1 and 2, and the leachate from the sample 3 did not detect any 1A or 2A elements, where the other samples did show detectable amounts of them. In one embodiment, the alkali metals tested for include aluminum, copper, and steel. In one embodiment, the samples were also tested for corrosion. The loosefill insulation product of sample 3 passes the corrosion test when examined under ASTM C764-19. Samples 1 and 2 do not pass the corrosion test when examined under ASTM C764-19 analysis. The loosefill insulation product of Samples 1 and 2 each had detectable amounts of group 1A and 2A elements when examined under SEM/EDS analysis. The loosefill insulation product of Sample 3 did not have detectable amounts of group 1A and 2A elements when examined under SEM/EDS analysis. The SEM analysis is performed using Phenom XL benchtop SEM instrument, with a field of view (FOV) of 269 microns (magnification “1000×), an accelerating voltage of 15 kV, under vacuum of 60 Pa. The samples are scanned and then undergo EDS analysis for Group 1A and Group 2A elements and any combination thereof. In one embodiment, the EDS analysis scans for C, O, Al, P, S, Mn, Ag, or any combination thereof. In another embodiment, the EDS analysis scans for C, O, Si, S, Cu, Re, or any combination thereof. In another embodiment, the EDS analysis scans for C, O, Na, Mg, Al, Si, S, Cr, Mn, Fe, and any combination thereof.

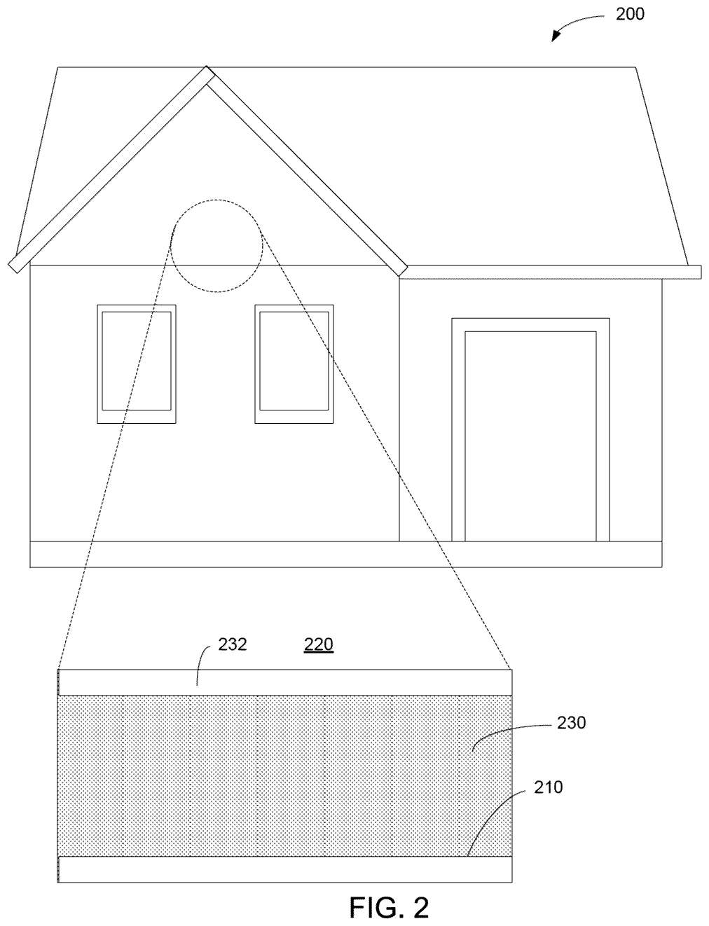

The insulation fibers described herein can advantageously be used as insulation materials in a variety of contexts, including insulation of building structures. Accordingly, another aspect of the disclosure is an insulated structure, the insulated structure having an interior surface (e.g., a surface of a wall, a ceiling, floor, an attic, a basement, or another building surface), and a plurality of coated fibers as described herein disposed against the interior surface, as seen in FIG. 2. In one embodiment, the insulated structure is house 200. The house can include an attic 220. The interior surface is a ceiling surface 210 facing an attic 220, with a plurality of coated fibers 230 as described herein disposed against the interior surface. There can be one or more layers of liner between the fibers 230 and the interior surface. In one embodiment the coated fibers 230 can be separated from the interior surface by one or more liners 232. Such liners 232 can perform multiple functions, such as retaining the fibers, or providing a moisture barrier. Such liners can be positioned in a structure below, above, or around the insulation as required. In another embodiment, the loosefill materials as described herein can be used in between wall studs or other enclosed cavity spaces.

Advantageously, the loosefill insulation fibers coated in the manner described above was not only able to pass the corrosion test, but also leaked less than detectable amounts of alkali and alkaline earth metals. The fibers have a longer shelf life, or half-life and are able to withstand humid temperatures without breakdown for longer than those fibers coated with the same materials but at higher concentrations.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Various Embodiments

Embodiment 1. A loosefill insulation product is disclosed. The loosefill insulation product can include a plurality of insulation fibers; and a coating on the plurality of insulation fibers. The coating can include a silicone; and an oil, and wherein the loosefill insulation product leaches less than detectable amounts of alkali or alkaline-earth metals based on the total weight of the loosefill insulation product when analyzed with SEM/EDS analysis.

Embodiment 2. The loosefill insulation product of embodiment 1, where the alkali or alkaline-earth metals can include sodium, calcium, potassium, or magnesium.

Embodiment 3. The loosefill insulation product of embodiment 1, where the coating can include less than 0.1 wt % of silicone based on the weight of the fibers.

Embodiment 4. The loosefill insulation product of embodiment 1, where the silicone has a number-average molecular weight of greater than 20 KDa.

Embodiment 5. The loosefill insulation product of embodiment 1, where the silicone is selected from the group consisting of alkyl-modified silicones, fluorosilicone, or any combination thereof.

Embodiment 6. The loosefill insulation product of embodiment 1, where the coating can include less than 0.7 wt % of oil based on the weight of the fibers.

Embodiment 7. The loosefill insulation product of embodiment 1, where the fibers comprise at least one organic material selected from the group consisting of animal fibers, cellulose-containing vegetable fibers, cotton, rayon granulated cork, redwood wool, recycled, ground, or shredded newspaper fibers, polyester, other thermoplastic fibers, or any combination thereof.

Embodiment 8. The loosefill insulation product of embodiment 1, where the fibers comprise at least one inorganic material selected from the group consisting of perlite, fibrous potassium titanate, alumina-silica fibers, micro quartz fibers, opacified colloidal alumina, zirconia fibers, carbon fibers, basalt fibers, aramid fibers, granulated charcoal, graphite fibers, cement fibers, rock fibers, slag fibers, glass wool, rock wool, or any combination thereof.

Embodiment 9. The loosefill insulation product of embodiment 1, where the fibers comprise glass fibers.

Embodiment 10. The loosefill insulation product of embodiment 9, where the fibers comprise glass fibers selected from the group consisting of borosilicate glass fibers, aluminosilicate glass fibers, aluminoborosilicate glass fibers, alkali-lime glass fibers, alumino-lime silicate glass fibers, or any combination thereof.

Embodiment 11. The loosefill insulation product of embodiment 9, where the glass fibers comprise a combination of two or more of SiO₂, Al₂O₃, CaO, MgO, B₂O₃, Na₂O, K₂O, and Fe₂O₃.

Embodiment 12. The loosefill insulation product of embodiment 1, where the oil can include at least one oil from the group consisting of vegetable oils, natural oils primarily unsaturated triglycerides such as corn oil, soya and coconut, mineral oils, or any combination thereof.

Embodiment 13. The loosefill insulation product of embodiment 1, where the oil can include mineral oil.

Embodiment 14. The loosefill insulation product of embodiment 1, where the oil can include paraffinic oils.

Embodiment 15. The loosefill insulation product of embodiment 1, where the oil does not comprise GMOK.

Embodiment 16. The loosefill insulation product of embodiment 1, where the oil is an undiluted oil.

Embodiment 17. The loosefill insulation product of embodiment 1, where the coating further can include an antistatic additive.

Embodiment 18. The loosefill insulation product of embodiment 1, where the coating further can include an antistatic additive of less than 1.50 wt % based on the weight of the fibers.

Embodiment 19. The loosefill insulation product of embodiment 1, where the coating further can include an antistatic additive selected from the group consisting of quaternary amines, triethanol amine salts of oxyacids of metals, polyethylene glycol, polypropylene glycol, a glycerol polyether, or any combination thereof.

Embodiment 20. The loosefill insulation product of embodiment 1, where the coating further can include a corrosion inhibitor.

Embodiment 21. The loosefill insulation product of embodiment 1, where the coating further can include an antistatic additive selected from the group, or any combination thereof.

Embodiment 22. A loosefill insulation product is disclosed. The loosefill insulation product can include a fiber insulation wool; and a coating on the fiber insulation wool. The fiber insulation wool can include a plurality of fibers. The coating can include a silicone; and an oil. The loosefill insulation product passes corrosion test in accordance to ASTM C764.

Embodiment 23. The loosefill insulation product of embodiment 22, where the alkali or alkaline-earth metals can include sodium, calcium, potassium, or magnesium.

Embodiment 24. The loosefill insulation product of embodiment 22, where the coating can include less than 0.1 wt % of silicone based on the weight of the fibers.

Embodiment 25. The loosefill insulation product of embodiment 22, where the silicone has a number-average molecular weight of greater than 20 KDa.

Embodiment 26. The loosefill insulation product of embodiment 22, where the silicone is selected from the group consisting of alkyl-modified silicones, fluorosilicone, or any combination thereof.

Embodiment 27. The loosefill insulation product of embodiment 22, where the coating can include less than 0.5 wt % of oil based on the weight of the fibers.

Embodiment 28. The loosefill insulation product of embodiment 22, where the fibers comprise at least one organic material selected from the group consisting of animal fibers, cellulose-containing vegetable fibers, cotton, rayon granulated cork, redwood wool, recycled, ground, or shredded newspaper fibers, polyester, other thermoplastic fibers, or any combination thereof.

Embodiment 29. The loosefill insulation product of embodiment 22, where the fibers comprise at least one inorganic material selected from the group consisting of perlite, fibrous potassium titanate, alumina-silica fibers, micro quartz fibers, opacified colloidal alumina, zirconia fibers, carbon fibers, basalt fibers, aramid fibers, granulated charcoal, graphite fibers, cement fibers, rock fibers, slag fibers, glass wool, rock wool, or any combination thereof.

Embodiment 30. The loosefill insulation product of embodiment 22, where the fibers comprise glass fibers.

Embodiment 31. The loosefill insulation product of embodiment 30, where the fibers comprise glass fibers selected from the group consisting of borosilicate glass fibers, aluminosilicate glass fibers, aluminoborosilicate glass fibers, alkali-lime glass fibers, alumino-lime silicate glass fibers, or any combination thereof.

Embodiment 32. The loosefill insulation product of embodiment 31, where the glass fibers comprise a combination of two or more of SiO₂, Al₂O₃, CaO, MgO, B₂O₃, Na₂O, K₂O, and Fe₂O₃.

Embodiment 33. The loosefill insulation product of embodiment 22, where the oil can include at least one oil from the group consisting of vegetable oils, natural oils primarily unsaturated triglycerides such as corn oil, soya and coconut, mineral oils, or any combination thereof.

Embodiment 34. The loosefill insulation product of embodiment 22, where the oil can include mineral oil.

Embodiment 35. The loosefill insulation product of embodiment 22, where the oil can include paraffinic oils.

Embodiment 36. The loosefill insulation product of embodiment 22, where the oil does not comprise GMOK.

Embodiment 37. The loosefill insulation product of embodiment 22, where the oil is an undiluted oil.

Embodiment 38. The loosefill insulation product of embodiment 22, where the coating further can include an antistatic additive.

Embodiment 39. The loosefill insulation product of embodiment 22, where the coating further can include an antistatic additive of less than 1.50 wt % based on the weight of the fibers.

Embodiment 40. The loosefill insulation product of embodiment 22, where the coating further can include an antistatic additive selected from the group consisting of quaternary amines, triethanol amine salts of oxyacids of metals, polyethylene glycol, polypropylene glycol, a glycerol polyether, or any combination thereof.

Embodiment 41. The loosefill insulation product of embodiment 22, where the coating further can include a corrosion inhibitor.

Embodiment 42. The loosefill insulation product of embodiment 22, where the coating further can include an antistatic additive selected from the group, or any combination thereof.

Embodiment 43. A method of making a loosefill insulation product is disclosed. The method of making the loosefill insulation product can include: applying a coating on a plurality of insulation fibers, where the coating can include a silicone; and an oil; and drying the coating on the plurality of insulation fibers to form a loosefill insulation product, where the loosefill insulation product leaches less than detectable amounts of alkali or alkaline-earth metals based on the total weight of the loosefill insulation product when analyzed with SEM/EDS analysis.

Embodiment 44. The method of embodiment 43, where the oil is sprayed on the fibers without dilution.

Embodiment 45. A method of making a loosefill insulation product is disclosed. The method can include applying a coating on a fiber insulation wool, where the fiber insulation wool can include a plurality of fibers, where the coating can include: a silicone; and an oil, and where the loosefill insulation product passes corrosion test according to ASTM C764.

Embodiment 46. The method of embodiment 45, where the oil is sprayed on the fibers without dilution.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A loosefill insulation product, comprising:
a plurality of insulation fibers; and
a coating on the plurality of insulation fibers, wherein the coating comprises:
a silicone; and
an oil, and wherein the loosefill insulation product leaches less than detectable amounts of alkali or alkaline-earth metals based on the total weight of the loosefill insulation product when analyzed with SEM/EDS analysis.

2. The loosefill insulation product of claim 1, wherein the alkali or alkaline-earth metals comprises sodium, calcium, potassium, or magnesium.

3. The loosefill insulation product of claim 1, wherein the coating comprises less than 0.1 wt % of silicone based on the weight of the fibers.

4. The loosefill insulation product of claim 1, wherein the silicone has a number-average molecular weight of greater than 20 KDa.

5. The loosefill insulation product of claim 1, wherein the silicone is selected from the group consisting of alkyl-modified silicones, fluorosilicone, or any combination thereof.

6. The loosefill insulation product of claim 1, wherein the coating comprises less than 0.7 wt % of oil based on the weight of the fibers.

7. The loosefill insulation product of claim 1, wherein the fibers comprise at least one organic material selected from the group consisting of animal fibers, cellulose-containing vegetable fibers, cotton, rayon granulated cork, redwood wool, recycled, ground, or shredded newspaper fibers, polyester, other thermoplastic fibers, or any combination thereof.

8. The loosefill insulation product of claim 1, wherein the fibers comprise at least one inorganic material selected from the group consisting of perlite, fibrous potassium titanate, alumina-silica fibers, micro quartz fibers, opacified colloidal alumina, zirconia fibers, carbon fibers, basalt fibers, aramid fibers, granulated charcoal, graphite fibers, cement fibers, rock fibers, slag fibers, glass wool, rock wool, or any combination thereof.

9. The loosefill insulation product of claim 1, wherein the fibers comprise glass fibers selected from the group consisting of borosilicate glass fibers, aluminosilicate glass fibers, aluminoborosilicate glass fibers, alkali-lime glass fibers, alumino-lime silicate glass fibers, or any combination thereof.

10. The loosefill insulation product of claim 9, wherein the glass fibers comprise a combination of two or more of SiO₂, Al₂O₃, CaO, MgO, B₂O₃, Na₂O, K₂O, and Fe₂O₃.

11. The loosefill insulation product of claim 1, wherein the oil comprises at least one oil from the group consisting of vegetable oils, natural oils primarily unsaturated triglycerides such as corn oil, soya and coconut, mineral oils, or any combination thereof.

12. The loosefill insulation product of claim 1, wherein the oil comprises mineral oil.

13. The loosefill insulation product of claim 1, wherein the oil comprises paraffinic oils.

14. The loosefill insulation product of claim 1, wherein the oil does not comprise GMOK.

15. The loosefill insulation product of claim 1, wherein the oil is an undiluted oil.

16. The loosefill insulation product of claim 1, wherein the coating further comprises an antistatic additive.

17. The loosefill insulation product of claim 1, wherein the coating further comprises an antistatic additive of less than 1.50 wt % based on the weight of the fibers.

18. The loosefill insulation product of claim 17, wherein the antistatic additive is selected from the group consisting of quaternary amines, triethanol amine salts of oxyacids of metals, polyethylene glycol, polypropylene glycol, a glycerol polyether, or any combination thereof.

19. A loosefill insulation product, comprising:
a fiber insulation wool; and
a coating on the fiber insulation wool, wherein the fiber insulation wool comprises a plurality of fibers,
where the coating comprises:
a silicone; and
an oil, and
wherein the loosefill insulation product passes corrosion test in accordance to ASTM C764.

20. A method of making a loosefill insulation product, comprising:
applying a coating on a plurality of insulation fibers, wherein the coating comprises:
a silicone; and
an oil; and
drying the coating on the plurality of insulation fibers to form a loosefill insulation product, wherein the loosefill insulation product leaches less than detectable amounts of alkali or alkaline-earth metals based on the total weight of the loosefill insulation product when tested by SEM/EDS analysis.
